(19) United States
(12) Patent Application Publication
(10) Pub. No.: US 2026/0319780 A1
(43) Pub. Date: Oct. 15, 2026

(54) SYSTEM FOR INTELLIGENT CODE DEPLOYMENT

(71) Applicant: BANK OF AMERICA CORPORATION, Charlotte, NC (US)

(72) Inventors: Venugopala Rao Randhi, Hyderabad (IN); Ramakrishna Padi, Hyderabad (IN); Jyothi Gaddam, Hyderabad (IN); Rama Venkata Kavali, Frisco, TX (US); Bondadi Leela Manohar, Hyderabad (IN)

(73) Assignee: BANK OF AMERICA CORPORATION, Charlotte, NC (US)

(21) Appl. No.: 19/174,686

(22) Filed: Apr. 9, 2025

(51) Int. Cl. G06F 8/65

(52) U.S. Cl. CPC G06F 8/65

(57) ABSTRACT

Systems, computer program products, and methods are described herein intelligent code deployment. An example system may receive a code change from a source and determine a deployment type based on the nature of the change and historical deployment data. The system may then determine deployment parameters, including execution timing, resource allocation, and rollback conditions, before deploying the code change. During deployment, the system may monitor real-time performance metrics, such as resource utilization, latency, and network traffic, to assess network functionality. If deviations from expected behavior are detected, the system may identify responsive actions, such as dynamic scaling, rollback execution, or security reconfigurations, and implement them in real time. Additionally, the system may generate an adaptive feedback loop, using insights from detected deviations and corrective actions to refine deployment parameters for future deployments, continuously improving performance, security, and efficiency.

### TECHNOLOGICAL FIELD

Example embodiments of the present disclosure relate to deployment strategies in software and system updates. More specifically, the embodiments pertain to an AI-driven, dynamically staged deployment framework that optimizes resource allocation, minimizes operational disruptions, enhances security validation, and enables proactive anomaly detection.

### BACKGROUND

Traditional deployment methodologies face challenges in ensuring seamless software updates, particularly in high-availability and mission-critical systems. Static deployment models often result in operational disruptions, inefficient resource allocation, and delayed detection of security vulnerabilities. As such, there is a need for an intelligent code deployment framework that automates and optimizes the deployment process using artificial intelligence, machine learning-based anomaly detection, dynamic resource determination, and decentralized approval mechanisms.

Applicant has identified a number of deficiencies and problems associated with code deployment. Many of these identified problems have been solved by developing solutions that are included in embodiments of the present disclosure, many examples of which are described in detail herein.

### BRIEF SUMMARY

Systems, methods, and computer program products are provided for intelligent code deployment.

In one aspect, a system for intelligent code deployment within a network is presented. The system comprising: a code change analysis subsystem, wherein the code analysis subsystem is configured to: receive, from a source, a code change; and determine a deployment type for the code change; a predictive deployment subsystem operatively coupled to the code change analysis subsystem, wherein the predictive deployment subsystem is configured to: determine deployment parameters for the code change based on at least the deployment type and historical deployment data; and deploy the code change with the deployment parameters; and a deployment monitoring subsystem operatively coupled to the predictive deployment subsystem, wherein the deployment monitoring subsystem is configured to: monitor the deployment of the code change; determine real-time performance metrics associated with the network functionality in response to the deployment, wherein the real-time performance metrics comprises at least resource utilization, latency, and network traffic; and detect deviations in network behavior based on the real-time performance metrics.

In some embodiments, the system further comprises a responsive action subsystem, wherein the responsive action subsystem is configured to: determine, in real-time, a responsive action associated with the detected deviations; dynamically implement the responsive action to rectify the detected deviations in the network behavior; and generate an adaptive feedback loop to adjust the deployment parameters for subsequent deployments based on the detected deviations and the implemented responsive actions.

In some embodiments, in determining the deployment type, the code change analysis subsystem is further configured to: determine component-level interdependencies within the network likely to result from the deployment of the code change; and determine the deployment type for each sub-task based on the determined component-level interdependencies.

In some embodiments, in receiving the code change from the source, the code change analysis subsystem is further configured to: scan the source to detect codebase modifications, script updates, and application changes; analyze, using a natural language processing (NLP) model, the codebase modifications, the script updates, and the application changes; and divide the code change into a plurality of sub-tasks based on the analysis.

In some embodiments, in deploying the code change, the predictive deployment subsystem is configured to: deploy the plurality of sub-tasks using the deployment parameters.

In some embodiments, in determining the deployment parameters, the predictive deployment subsystem is further configured to: train a temporal deployment model with historical deployment data, wherein the historical deployment data comprises historical deployment type associated with historical code change deployments, historical performance metrics of the network in response to deployment of each historical code change, historical deviations in network behavior identified based on the historical performance metrics, and historical responsive actions implemented to rectify the historical deviations; and deploy the temporal deployment model on the deployment type for the code change to determine the deployment parameters.

In some embodiments, the system further comprises a resource optimization subsystem operatively coupled to the predictive deployment subsystem, wherein the resource optimization subsystem is configured to: determine, using an adaptive optimization model, an optimal set of deployment resources for deploying the code change based on deployment parameters, available deployment resources in the network, historical resource utilization patterns for historical code change deployments, the real-time performance metrics, and simulated deployment scenarios; and transmit the optimal set of deployment resources to the predictive deployment subsystem.

In some embodiments, the predictive deployment subsystem is further configured to: deploy the code change with the deployment parameters using the optimal set of deployment resources.

In some embodiments, the system further comprises a deployment authorization subsystem operatively coupled to the predictive deployment subsystem, wherein the deployment authorization subsystem is configured to: generate a smart contract that encodes conditional requirements and the deployment parameters for the deployment of the code change, wherein the conditional requirements comprise at least deployment approval policies for authorized stakeholders; and record the smart contract in a distributed ledger.

In some embodiments, the predictive deployment subsystem is further configured to: retrieve, from the distributed ledger, the smart contract; and trigger automated deployment of the code change upon fulfillment of the conditional requirements.

In another aspect, a method for intelligent code deployment within a network is presented. The method comprises: receiving, by a code change analysis subsystem, a code change from a source; determining, by the code change analysis subsystem, a deployment type for the code change; determining, by a predictive deployment subsystem, deployment parameters for the code change based on at least the deployment type and historical deployment data; deploying, by the predictive deployment subsystem, the code change using the deployment parameters; monitoring, by a deployment monitoring subsystem, the deployment of the code change; determining, by the deployment monitoring subsystem, real-time performance metrics associated with network functionality in response to the deployment, wherein the real-time performance metrics comprise at least resource utilization, latency, and network traffic; and detecting, by the deployment monitoring subsystem, deviations in network behavior based on the real-time performance metrics.

In yet another aspect, a computer program product for intelligent code deployment within a network is presented. The computer program product comprising a non-transitory computer-readable medium comprising code, which when executed, causes a processing device to: receive a code change from a source; determine a deployment type for the code change; determine deployment parameters for the code change based on at least the deployment type and historical deployment data; deploy the code change using the deployment parameters; monitor the deployment of the code change; determine real-time performance metrics associated with network functionality in response to the deployment, wherein the real-time performance metrics comprise at least resource utilization, latency, and network traffic; and detect deviations in network behavior based on the real-time performance metrics.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for intelligent code deployment, in accordance with an embodiment of the invention;

FIG. 2 illustrates a process flow for intelligent code deployment, in accordance with an embodiment of the invention.

### DETAILED DESCRIPTION

### Overview

Traditional deployment strategies face several technical challenges in modern software release management. Existing deployment approaches often result in operational disruptions, inefficient resource allocation, delayed vulnerability detection, and reactive anomaly response, leading to increased security exposures and system inefficiencies. One primary issue is the impact of deployments on system stability, particularly during peak operational hours. Unoptimized deployment strategies can introduce service interruptions, negatively affecting user experience and resulting in financial and reputational losses.

Resource allocation is another important consideration. Static provisioning models often lead to inefficiencies—over-provisioning results in wasted resources, while under-provisioning causes system bottlenecks, degrading transaction processing times. Existing frameworks do not dynamically adjust resource allocation based on real-time workload variations.

Security validation remains a significant concern in conventional deployment processes. Static testing frameworks fail to adapt to dynamic user behaviors, evolving cybersecurity threats, and changing operational conditions. Newly deployed updates may introduce security vulnerabilities that remain undetected until unauthorized access and/or modification occurs. Furthermore, anomaly detection mechanisms in traditional systems are predominantly reactive, identifying threats only after they have caused system damage.

Another challenge arises in environments protected by advanced cybersecurity solutions, such as endpoint detection and response (EDR) platforms. Deploying updates across such systems often leads to unintended interactions, introducing new vulnerabilities and increasing the attack surface. Additionally, large-scale deployments require extensive validation through threat simulations and integration testing. Traditional methods struggle to scale effectively, leading to overwhelmed validation systems, inefficient resource allocation, and extended deployment timelines.

These challenges necessitate an intelligent, adaptive, and scalable deployment framework that proactively optimizes deployment timing, ensures real-time security validation, and dynamically allocates resources based on predictive analytics. A system addressing these issues would improve deployment reliability, enhance security postures, and optimize resource utilization.

Embodiments of the present disclosure provide an AI-driven adaptive deployment framework that improves software release management by automating validation, optimizing resource allocation, and maintaining secure approval mechanisms. An example system scans codebases and application changes, analyzes modifications using AI models such as Bidirectional Encoder Representations from Transformers (BERT), and segments updates into deployment sub-tasks based on dependencies, required resources, and validation requirements. In addition, the example system employs Graph Neural Networks (GNN) to assess interdependencies between components, ensuring efficient sequencing of tasks. The example system then automates deployment planning by generating resource requirements, identifying test cases, and scheduling post-validation tasks. A decentralized approval process using smart contracts facilitates stakeholder validation, providing traceability and reducing ambiguity before finalizing the release schedule.

The example system continuously monitors the deployment lifecycle across development, quality assurance (QA), and performance testing (PT) phases, identifying potential failures, unmet service-level agreements (SLAs), and resource constraints. The example system then integrates automated corrective actions to resolve detected issues before deployment, reducing failures in production environments. To determine optimal release timing, the example system applies deep learning models such as Prophet and Long Short-Term Memory (LSTM) networks, which analyze historical deployment data, system performance metrics, and workload patterns. A Random Forest classifier, in combination with Recurrent Neural Networks (RNN) with LSTM, predicts deployment success by cross-referencing real-time validation results with historical system behavior.

To improve pre-deployment validation, the example system supports user acceptance testing (UAT) and sandbox environments that replicate production conditions, enabling real-time dynamic test case generation that simulates user behavior across distributed systems. Pre-and post-deployment verification mechanisms utilize autoencoders to validate backup integrity, confirm server readiness, and execute automated integration and functional tests to minimize the exposure of failures after deployment. The example system enforces a distributed governance model through smart contracts, ensuring that development teams, QA, business owners, and application managers approve deployments in a transparent and traceable manner.

In addition to deployment validation, the example system employs anomaly detection and resource determination using Gaussian Mixture Models (GMM) to cluster normal resource usage behaviors and identify deviations during deployment. The example system further optimizes resource allocation dynamically through Deep Reinforcement Learning (DRL) models, which analyze historical trends and real-time workload conditions to adjust computing resources efficiently. By integrating AI-driven predictive modeling, automated validation, decentralized approvals, and real-time monitoring, the example system improves the reliability, security, and efficiency of software deployments while minimizing operational disruptions and optimizing infrastructure utilization.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

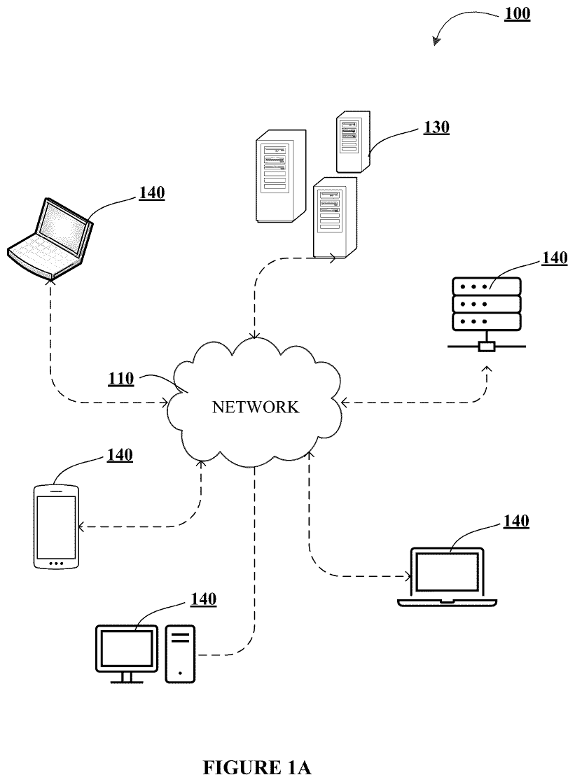

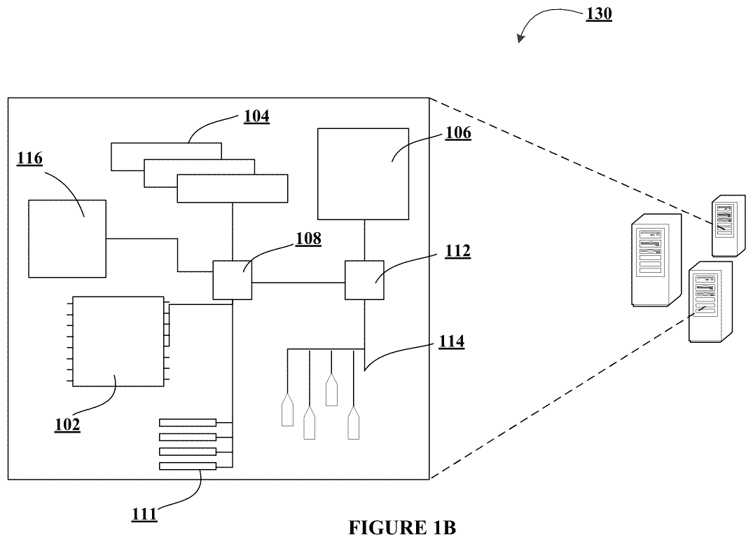

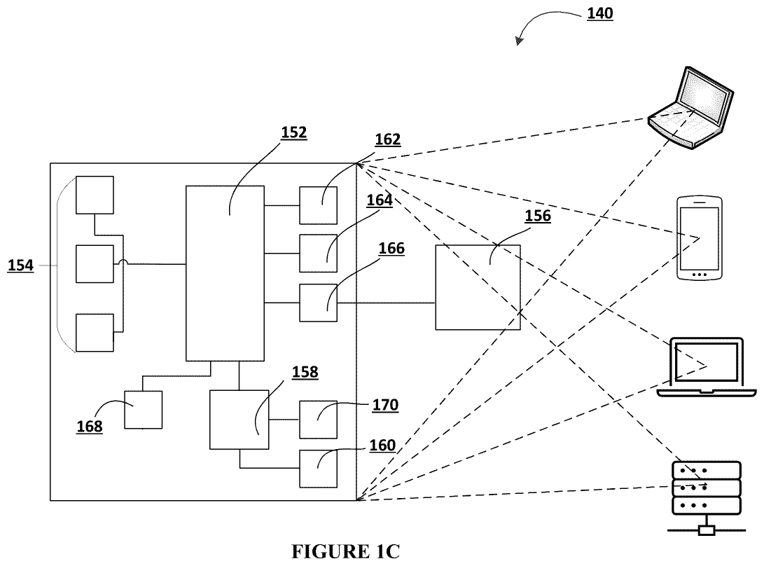

FIGS. 1A-1C illustrate technical components of an exemplary distributed computing environment for intelligent code deployment 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The code change analysis subsystem may be configured to receive a code change from a source and analyze its characteristics to determine an appropriate deployment strategy. The code change analysis subsystem interacts with the predictive deployment subsystem by supplying deployment-relevant information, such as the nature of the code change, its dependencies, and the required deployment type. The code change analysis subsystem may scan the source repository or other designated locations to detect codebase modifications, script updates, or application changes. The code change analysis subsystem may utilize natural language processing (NLP) models to analyze the content of the modifications and extract metadata, such as affected components and required resources. Based on this analysis, the code change analysis subsystem may divide the code change into a set of deployment sub-tasks and assess component-level interdependencies to optimize deployment sequencing. Additionally, the code change analysis subsystem may reference historical deployment data to classify the code change into a deployment type, such as incremental rollout, canary deployment, or blue-green deployment, ensuring alignment with operational and security policies. The deployment type determination may be based on pre-defined rules, machine learning models, or graph-based dependency analysis. Once the deployment type and structure are determined, the code change analysis subsystem may transmit the analyzed data to the predictive deployment subsystem to facilitate deployment planning and execution.

The predictive deployment subsystem may be configured to determine deployment parameters for the code change based on inputs received from the code change analysis subsystem and historical deployment data. The predictive deployment subsystem may interact with the deployment monitoring subsystem to track deployment performance and identify deviations that may require corrective actions. To determine deployment parameters, the predictive deployment subsystem may reference a temporal deployment model, which may be trained on historical deployment data, including previous deployment types, performance metrics, and detected anomalies. The deployment parameters may include factors such as optimal resource allocation, scheduling preferences, rollback conditions, and post-deployment validation criteria. The predictive deployment subsystem may further leverage machine learning models, such as Long Short-Term Memory (LSTM) networks, Random Forest classifiers, or reinforcement learning models, to optimize deployment conditions based on real-time system state and workload predictions. Once the deployment parameters are determined, the subsystem may deploy the code change by executing deployment tasks in accordance with the defined parameters. In cases where the deployment involves multiple sub-tasks, the predictive deployment subsystem may sequence the execution based on component-level interdependencies provided by the code change analysis subsystem. Additionally, if an optimal resource allocation strategy is available from the resource optimization subsystem, the subsystem may use the designated computing, storage, and network resources to enhance deployment efficiency. The predictive deployment subsystem may also interact with the deployment authorization subsystem to ensure compliance with predefined approval policies. If the deployment requires stakeholder approval, the predictive deployment subsystem may retrieve the corresponding smart contract from a distributed ledger before initiating deployment, verify fulfillment of conditional requirements, including stakeholder approvals, security validations, and compliance checks, before executing the deployment, and/or trigger automated deployment only if all smart contract conditions are met, ensuring compliance with governance policies and operational constraints. The predictive deployment subsystem may also support conditional execution logic, wherein deployments are automatically scheduled, delayed, or halted based on smart contract conditions. If the retrieved smart contract specifies dependencies, such as sequential deployment requirements or pre-release security tests, the predictive deployment subsystem may coordinate with the deployment monitoring subsystem to ensure these conditions are satisfied before proceeding. In cases where the smart contract mandates post-deployment verification, the deployment monitoring subsystem may interact with the deployment monitoring subsystem to collect and validate performance metrics. If an issue arises, it may trigger interactions with the responsive action subsystem to either remediate the problem or roll back the deployment.

The deployment monitoring subsystem may be configured to monitor the deployment of a code change, collect real-time performance metrics, and detect deviations in network behavior. This deployment monitoring subsystem may interact with the predictive deployment subsystem to provide feedback on deployment performance and with the responsive action subsystem to initiate corrective actions when necessary. During deployment, the deployment monitoring subsystem may collect real-time performance metrics, including but not limited to resource utilization, latency, network traffic, error rates, and system throughput. These metrics may be obtained through system monitoring tools, telemetry data, and logs generated by the deployed application and infrastructure components. The deployment monitoring subsystem may employ anomaly detection models, such as Gaussian Mixture Models (GMM), autoencoders, or recurrent neural networks (RNNs), to analyze deviations from expected performance baselines. If deviations are detected, the deployment monitoring subsystem may categorize them based on severity, potential causes, and impact on system stability. The deployment monitoring subsystem may generate alerts or recommendations for corrective actions, which are communicated to the responsive action subsystem for further processing. Additionally, it may log detected deviations and associate them with historical deployment data, enabling the predictive deployment subsystem to refine future deployment parameters based on observed trends. In scenarios where the deployment is executed in multiple stages, the deployment monitoring subsystem may continuously assess intermediate results and determine whether the deployment should proceed, pause, or roll back based on predefined policies or real-time system behavior.

The responsive action subsystem may be configured to determine and implement corrective actions in response to deviations detected by the deployment monitoring subsystem. The responsive action subsystem may interact with the predictive deployment subsystem to refine future deployment strategies and ensure adaptive improvements based on past deployment outcomes. Upon receiving an alert regarding a detected deviation, the subsystem may analyze the deviation type, severity, and potential root causes using AI-driven anomaly classification models, such as decision trees, support vector machines (SVMs), or deep learning-based classifiers. Based on this analysis, the subsystem may select an appropriate responsive action, which may include: (i) adjusting resource allocations dynamically to mitigate performance bottlenecks, (ii) triggering automated rollback procedures if a deployment failure meets predefined rollback conditions, (iii) applying security patches or reconfigurations if the deviation is identified as a security threat, and/or (iv) re-scheduling subsequent deployment phases if the detected deviation suggests suboptimal deployment timing. The responsive action subsystem may implement corrective measures in real time by interacting with system infrastructure, deployment tools, or cloud-based resource management platforms. Additionally, the responsive action subsystem may generate an adaptive feedback loop by logging the deviation, the applied corrective action, and its effectiveness. This data may be fed into the predictive deployment subsystem, allowing the system to refine future deployment strategies and reduce the likelihood of similar issues. The responsive action subsystem may also interact with the deployment authorization subsystem in cases where human intervention or stakeholder approval is required before implementing a corrective action, particularly for mission-critical systems.

The resource optimization subsystem may be configured to determine an optimal set of deployment resources for deploying the code change. The resource optimization subsystem may interact with the predictive deployment subsystem to supply optimized resource allocation recommendations and with the deployment monitoring subsystem to continuously adjust resource utilization based on real-time performance data. To determine the optimal resource allocation, the resource optimization subsystem may evaluate multiple factors, including: (i) available deployment resources in the network, such as computing power, storage capacity, and network bandwidth, (ii) historical resource utilization patterns, derived from past deployments, to predict the expected resource demands of similar deployments, (iii) real-time performance metrics, obtained from the deployment monitoring subsystem, to detect under-provisioning or over-provisioning exposures, or (iv) simulated deployment scenarios, using predictive modeling to assess different resource allocation strategies before finalizing the deployment plan.

The resource optimization subsystem may employ an adaptive optimization model, which may integrate machine learning algorithms (e.g., Random Forest, Reinforcement Learning, or Bayesian Optimization) to adjust resource allocation dynamically. If real-time workload conditions deviate significantly from initial projections, the resource optimization subsystem may recompute resource requirements and suggest modifications to the active deployment process. Once an optimal resource allocation strategy is determined, the subsystem may transmit the recommended set of deployment resources to the predictive deployment subsystem, which uses these resources to execute the deployment. In distributed or cloud-based environments, the resource optimization subsystem may also interact with orchestration platforms (e.g., Kubernetes, serverless frameworks, or cloud auto-scaling services) to provision, allocate, or deallocate resources dynamically.

The deployment authorization subsystem may be configured to enforce deployment governance by generating and managing smart contracts that encode conditional requirements and deployment parameters. The deployment authorization subsystem may interact with the predictive deployment subsystem to maintain that only authorized deployments are executed and with the distributed ledger to record and verify deployment approvals. To facilitate decentralized deployment authorization, the deployment authorization subsystem may: (i) generate a smart contract that encodes at least deployment approval policies, stakeholder authorization rules, security validation requirements, and rollback conditions, (ii) record the smart contract in a distributed ledger to establish an immutable, tamper-resistant record of the deployment conditions and approval workflow, and/or (iii) facilitate verifiable approval by ensuring that only authorized stakeholders (e.g., DevOps engineers, security teams, business owners) can approve, modify, or reject a deployment request before execution. The deployment authorization subsystem may integrate with distributed ledger technologies to enable transparent and decentralized deployment governance. Upon a deployment request, the predictive deployment subsystem may query the deployment authorization subsystem to retrieve the corresponding smart contract and verify whether all encoded conditions have been met. The deployment authorization subsystem may also support multi-signature validation, ensuring that certain high-exposure deployments require approval from multiple stakeholders before proceeding. In cases where deployment conditions are not met, the deployment authorization subsystem may trigger an alert, requesting additional approvals or modifications before deployment execution. If necessary, the deployment authorization subsystem may interact with the responsive action subsystem to implement corrective actions, such as revalidating deployment parameters or enforcing a rollback.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

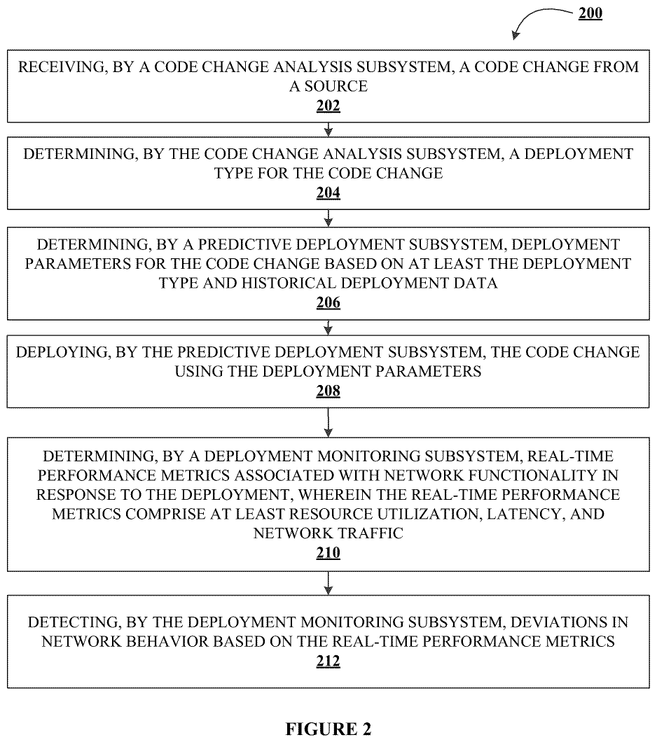

FIG. 2 illustrates a process flow for intelligent code deployment, in accordance with an embodiment of the invention. As shown in block 202, the process flow includes receiving, by a code change analysis subsystem, a code change from a source. As described herein, the code change analysis subsystem may be configured to retrieve code modifications, script updates, and application changes from a variety of sources, including version control systems (e.g., Git, Mercurial), cloud-based repositories, local development environments, and automated CI/CD pipelines. The source may contain individual code commits, feature branches, patch files, configuration updates, or containerized application artifacts.

Upon receiving the code change, the code change analysis subsystem may scan the source to detect specific modifications, such as alterations to configuration files, dependencies, function calls, and API endpoints. This scanning process may include static code analysis, dependency resolution, and security vulnerability assessment. In specific embodiments, the code change analysis subsystem may utilize a natural language processing (NLP) model to analyze commit messages, code comments, and associated metadata. The NLP model may determine the scope and intent of the code change (e.g., bug fix, feature enhancement, security patch), the affected components and dependencies within the software architecture, and/or the potential exposure level based on historical deployment data and past issues associated with similar changes.

In specific embodiments, the code change analysis subsystem may divide the received code change into a plurality of sub-tasks. The subdivision may be based on component dependencies, maintaining that tightly coupled modules are deployed together, required computing resources, such that resource-intensive updates are scheduled appropriately, security requirements, ensuring that critical updates undergo additional validation, and/or service impact analysis, determining whether the update affects high-availability components.

As shown in block 204, the process flow includes determining, by the code change analysis subsystem, a deployment type for the code change. The deployment type may be selected based on various factors, including the nature of the code change, its impact on system functionality, historical deployment outcomes, and real-time system conditions. The code change analysis subsystem may use predefined rules, dependency analysis, and machine learning models to classify the code change into one or more deployment types. In specific embodiments, the code change analysis subsystem may first analyze the component-level interdependencies associated with the received code change. This process may involve dependency graphs, graph neural networks (GNNs), or static code analysis tools to identify how the modified components interact with other parts of the system. The code change analysis subsystem may determine whether the code change affects isolated components, shared libraries, or critical infrastructure, which influences the deployment type selection.

The deployment type may be categorized into approaches such as incremental rollouts, blue-green deployments, canary deployments, shadow deployments, or full-scale releases. For example, if the code change affects core system services, a blue-green deployment may be selected to ensure seamless rollback capabilities. If the change introduces new experimental features, a canary deployment may be used to validate its impact on a small subset of users before a wider release. In cases where security patches must be applied immediately, a hotfix deployment strategy may be initiated.

As shown in block 206, the process flow includes determining, by a predictive deployment subsystem, deployment parameters for the code change based on at least the deployment type and historical deployment data. The predictive deployment subsystem may use machine learning models, rule-based decision systems, and real-time system analytics to optimize the deployment strategy for the received code change. To generate deployment parameters, the predictive deployment subsystem may reference a temporal deployment model trained on historical deployment data. This data may include previous deployment types, system performance metrics, failure rates, detected anomalies, and remediation actions associated with past code deployments. The predictive deployment subsystem may apply supervised learning models, such as Random Forest classifiers or Gradient Boosting Machines (e.g., XGBoost), as well as time-series forecasting models, such as Long Short-Term Memory (LSTM) networks or Prophet, to predict the potential impact of the deployment.

The deployment parameters determined by the predictive deployment subsystem may include, (i) optimal timing for deployment execution, such that the update is rolled out during low-traffic periods to minimize system disruptions, (ii) resource allocation requirements, specifying the computing, storage, and network resources necessary for successful deployment, (iii) rollback criteria and contingency planning, defining conditions under which an automated rollback should be triggered in response to failures or anomalies, (iv) validation and testing requirements, indicating whether sandbox testing, user acceptance testing (UAT), or integration tests must be conducted before full deployment, and/or deployment sequencing, defining the execution order of deployment sub-tasks based on component dependencies and system impact.

In specific embodiments, the resource optimization subsystem may provide real-time resource allocation updates to the predictive deployment subsystem, such that the deployment process does not exceed available computing, storage, and network capacity. The resource optimization subsystem may dynamically assess system conditions and adjust resource provisioning strategies based on real-time workload patterns, historical deployment data, and predictive modeling techniques. In this regard, the resource optimization subsystem may implement a combination of supervised learning, reinforcement learning, and heuristic-based optimization techniques to determine the optimal set of resources required for a given deployment. Historical deployment data, including previous resource utilization patterns, system performance metrics, and workload distribution trends, may be used to train machine learning models that predict the optimal configuration for new deployments.

The resource optimization subsystem may utilize time-series forecasting models, such as Long Short-Term Memory (LSTM) networks, Prophet, or autoregressive integrated moving average (ARIMA), to predict fluctuations in resource demand. By analyzing historical trends in CPU, memory, and network utilization, these models may forecast peak and low-demand periods, allowing the system to allocate resources proactively. In addition to predictive modeling, the subsystem may implement reinforcement learning (RL) techniques, such as Deep Q-Networks (DQN), Proximal Policy Optimization (PPO), or Advantage Actor-Critic (A2C), to optimize real-time resource allocation. These RL-based models may continuously learn from system feedback, adjusting deployment resources dynamically based on changing workload conditions and performance constraints. The RL agent may receive state inputs such as real-time system load, active network connections, database query latencies, and infrastructure availability, and take actions to allocate or deallocate resources accordingly.

To refine resource allocation efficiency further, the resource optimization subsystem may leverage unsupervised learning techniques, such as Gaussian Mixture Models (GMM) or K-Means clustering, to classify different deployment scenarios based on resource consumption patterns. These clustering techniques may allow the system to detect anomalous resource usage behaviors, preventing excessive over-provisioning or under-provisioning of infrastructure. The resource optimization subsystem may also incorporate Bayesian Optimization and Genetic Algorithms to fine-tune deployment parameters, searching for an optimal resource allocation strategy that balances cost, performance, and fault tolerance. Bayesian Optimization may be used to dynamically adjust deployment configurations in response to changing conditions, while Genetic Algorithms may explore various resource allocation strategies in parallel, selecting the best-performing configuration for execution.

In distributed computing environments, such as multi-cloud or edge deployments, the resource optimization subsystem may coordinate with cloud orchestration frameworks (e.g., Kubernetes, Docker Swarm, Apache Mesos) to dynamically assign deployment workloads across geographically distributed clusters. The resource optimization subsystem may factor in network latency, data locality, bandwidth constraints, and regional traffic distribution to determine the most efficient resource assignment strategy. Furthermore, the resource optimization subsystem may integrate with intelligent auto-scaling mechanisms, adjusting deployment resources dynamically in response to system demands. To ensure system-wide optimization, the resource optimization subsystem may continuously monitor real-time metrics, including CPU load, disk I/O, memory consumption, network throughput, and transaction processing times, and adjust resource allocations accordingly.

As shown in block 208, the process flow includes deploying, by the predictive deployment subsystem, the code change using the deployment parameters. The deployment process is executed based on the parameters determined in block 206, such that the update is rolled out in a controlled, optimized, and secure manner. The predictive deployment subsystem may initiate the deployment by sequencing and executing the deployment sub-tasks identified by the code change analysis subsystem. The deployment process may involve multiple stages, including pre-deployment validation, progressive rollout, and post-deployment verification. The predictive deployment subsystem may also integrate with container orchestration platforms (e.g., Kubernetes, Docker Swarm), cloud-based deployment tools, or serverless function managers to facilitate resource provisioning and application deployment.

If the deployment involves multiple sub-tasks, the predictive deployment subsystem may implement task prioritization and dependency resolution such that interdependent components are deployed in the correct order. For instance, database schema updates may be executed before application logic changes to prevent compatibility issues. The deployment execution may be structured according to the determined deployment type, such as: (i) incremental rollout—gradually deploying the code change to a subset of users or systems before expanding to full deployment, (ii) blue-green deployment—redirecting traffic to an updated environment while keeping the previous version as a rollback option, (iii) canary deployment—deploying to a small group of users first and expanding the rollout based on performance and feedback, and (iv) rolling update—sequentially replacing instances of the application without downtime.

In specific embodiments, the predictive deployment subsystem may interact with the deployment authorization subsystem before initiating deployment to retrieve a smart contract stored in a distributed ledger. The smart contract may encode deployment conditions, required approvals, compliance policies, and rollback criteria, ensuring that deployment governance is enforced in a decentralized, transparent, and tamper-resistant manner. The deployment authorization subsystem may generate and store the smart contract in distributed ledger (e.g., permissioned distributed ledger), allowing authorized stakeholders to review and approve deployment requests before execution. The smart contract conditions may include multiple stakeholder approval policies, requiring explicit authorization from relevant entities before deployment can proceed. These stakeholders may include development teams, security teams, business owners, application managers, site reliability engineers (SREs), DevOps personnel, and/or the like.

In specific embodiments, the approval mechanism encoded within the smart contract may implement multi-signature authentication, where a quorum-based approach is used to authorize deployments. For instance, a deployment may require at least 3 out of 5 designated stakeholders to approve before execution. The smart contract may also define role-based access control (RBAC) policies, ensuring that only authorized personnel can approve, modify, or reject deployment requests. In some implementations, the smart contract conditions may include predefined security validation steps, requiring successful completion of automated vulnerability scans, static and dynamic application security testing (SAST/DAST) for compliance with best practices, exposure simulations and penetration testing.

Additionally, the smart contract may encode rollback policies, specifying conditions under which an automated rollback should be triggered. If the deployment monitoring subsystem detects significant deviations in system performance, security anomalies, or service disruptions, the smart contract may autonomously authorize a rollback to a stable version. Once all encoded conditions within the smart contract are met, the predictive deployment subsystem may proceed with deployment execution. If any approval conditions are unmet, security validations fail, or compliance requirements are not satisfied, the deployment process may be delayed or blocked until the necessary approvals are obtained. The system may generate a deployment authorization log, recorded in the distributed ledger, such that all approvals and modifications are fully auditable and traceable for future reference.

As shown in block 210, the process flow includes determining, by a deployment monitoring subsystem, real-time performance metrics associated with network functionality in response to the deployment, wherein the real-time performance metrics comprise at least resource utilization, latency, and network traffic. The deployment monitoring subsystem may continuously track the operational impact of the deployment by collecting and analyzing system performance data. The deployment monitoring subsystem may receive telemetry data, system logs, and distributed tracing information from various sources, including server instances, cloud infrastructure, microservices, network routers, and application monitoring agents. The deployment monitoring subsystem may integrate with observability platforms such as Prometheus, OpenTelemetry, Elasticsearch, or cloud-native monitoring services to facilitate comprehensive performance tracking. The real-time performance metrics monitored by the subsystem may include resource utilization, including CPU load, memory consumption, disk I/O, and network bandwidth usage, latency measurements, tracking end-to-end request processing times, database query latencies, and API response times, network traffic patterns, identifying changes in request throughput, packet loss, and connection failures, and/or error rates and system anomalies, capturing failed requests, service crashes, or deviations from expected system behavior.

To improve monitoring effectiveness, the deployment monitoring subsystem may implement AI-driven anomaly detection models. These models may include Gaussian Mixture Models (GMM) and Isolation Forests for clustering normal and abnormal system behaviors based on historical deployment data, autoencoders and variational autoencoders (VAEs) for unsupervised anomaly detection, allowing the system to identify subtle deviations from expected performance baselines, recurrent neural networks (RNNs) and LSTM networks for time-series anomaly prediction, forecasting potential system degradations before they occur, and/or hidden Markov models (HMMs) to detect unexpected state transitions in distributed systems, flagging components that may be at exposure of failure.

The deployment monitoring subsystem may operate in multiple observation modes, including real-time streaming analysis for immediate anomaly detection and batch processing for long-term trend analysis. In certain implementations, the deployment monitoring subsystem may use predictive analytics models to correlate deployment events with observed system behavior, determining whether a specific deployment introduced performance degradation or instability. The observed real-time metrics may be stored in a historical deployment repository, enabling the system to refine deployment strategies over time. These records may also be used by the predictive deployment subsystem for future performance forecasting and exposure assessment.

As shown in block 212, the process flow includes detecting, by the deployment monitoring subsystem, deviations in network behavior based on the real-time performance metrics collected in block 210. The deployment monitoring subsystem may analyze observed system behaviors and compare them to historical performance baselines, predefined service-level agreements (SLAs), and real-time anomaly detection models to identify deviations that indicate performance degradation, security exposures, or unexpected system behavior. The deployment monitoring subsystem may utilize ML and AI-driven anomaly detection techniques to classify and assess detected deviations. These techniques may include supervised learning models, such as Random Forest, XGBoost, and Support Vector Machines (SVMs), trained on labeled historical deployment data to distinguish between expected and abnormal behavior, unsupervised learning models, including K-Means clustering, Gaussian Mixture Models (GMM), and Isolation Forests, to identify outliers in resource consumption, latency fluctuations, and network anomalies without requiring labeled datasets, deep learning-based anomaly detection, using Autoencoders, LSTMs, and Transformer-based models to detect subtle, high-dimensional deviations that may indicate security breaches or system performance deterioration, and graph neural networks (GNNs) for dependency analysis, identifying cascading failures and interdependencies between system components that may contribute to performance issues.

The detected deviations may be classified into categories such as: performance deviations (increased latency, resource exhaustion, or network congestion), security exposures (unauthorized access patterns, unexpected API calls, or data integrity violations), deployment failures (crashes, failed service restarts, or corrupted deployment artifacts), and/or operational inefficiencies (suboptimal resource allocation leading to over-provisioning or underutilization).

Upon detecting a deviation, the deployment monitoring subsystem may trigger a responsive action by interacting with the responsive action subsystem. The corrective action may be determined dynamically based on the severity and impact of the detected deviation. Examples of responsive actions include: (i) scaling resource dynamically—adjusting CPU, memory, or network bandwidth in real time to mitigate load imbalances, (ii) triggering an automated rollback—reverting the deployment to a previous stable version if system instability is detected, (iii) deploying security patches or configurations—modifying security policies, applying firewall rules, or isolating affected components in response to security deviations, (iv) reconfiguring network paths—adjusting traffic routing or load balancers to distribute workloads more efficiently, and/or (v) deploying subsequent deployment phases—if a deviation is detected in an incremental rollout, further deployment may be halted until the issue is resolved.

The responsive action subsystem may generate an adaptive feedback loop, where information about detected deviations and applied corrective actions is stored in a historical deployment repository. This data may be analyzed to refine future deployment strategies by feeding into the predictive deployment subsystem. Over time, this feedback loop allows the system to: (i) improve anomaly detection thresholds, reducing false positives and increasing proactive mitigation, (ii) refine rollback and recovery policies, such that automatic remediation aligns with system priorities, and/or (iii) optimize deployment parameters dynamically, adjusting deployment execution based on past deviations and real-time system health.

Additionally, the responsive action subsystem may interface with the deployment authorization subsystem if a corrective action requires manual intervention or approval. If a responsive action involves critical infrastructure modifications, high-exposure rollbacks, or security-sensitive patches, the system may consult a smart contract stored in the distributed ledger to enforce governance policies before execution.

In specific embodiments, the deployment monitoring subsystem may continue tracking system behavior post-correction, to make sure that responsive actions were effective. If issues persist, the deployment monitoring subsystem may escalate the event to human operators (e.g., users) or integrate with incident management systems, such as IT Service Management (ITSM) platforms, to facilitate manual intervention.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for intelligent code deployment within a network, the system comprising:
a code change analysis subsystem, wherein the code analysis subsystem is configured to:
receive, from a source, a code change; and
determine a deployment type for the code change;
a predictive deployment subsystem operatively coupled to the code change analysis subsystem, wherein the predictive deployment subsystem is configured to:
determine deployment parameters for the code change based on at least the deployment type and historical deployment data; and
deploy the code change with the deployment parameters; and
a deployment monitoring subsystem operatively coupled to the predictive deployment subsystem, wherein the deployment monitoring subsystem is configured to:
monitor the deployment of the code change;
determine real-time performance metrics associated with the network functionality in response to the deployment, wherein the real-time performance metrics comprises at least resource utilization, latency, and network traffic; and
detect deviations in network behavior based on the real-time performance metrics.

2. The system of claim 1, further comprising a responsive action subsystem, wherein the responsive action subsystem is configured to:
determine, in real-time, a responsive action associated with the detected deviations;
dynamically implement the responsive action to rectify the detected deviations in the network behavior; and
generate an adaptive feedback loop to adjust the deployment parameters for subsequent deployments based on the detected deviations and the implemented responsive actions.

3. The system of claim 1, wherein, in determining the deployment type, the code change analysis subsystem is further configured to:
determine component-level interdependencies within the network likely to result from the deployment of the code change; and
determine the deployment type for each sub-task based on the determined component-level interdependencies.

4. The system of claim 1, wherein, in receiving the code change from the source, the code change analysis subsystem is further configured to:
scan the source to detect codebase modifications, script updates, and application changes;
analyze, using a natural language processing (NLP) model, the codebase modifications, the script updates, and the application changes; and
divide the code change into a plurality of sub-tasks based on the analysis.

5. The system of claim 4, wherein, in deploying the code change, the predictive deployment subsystem is configured to:
deploy the plurality of sub-tasks using the deployment parameters.

6. The system of claim 1, wherein, in determining the deployment parameters, the predictive deployment subsystem is further configured to:
train a temporal deployment model with historical deployment data, wherein the historical deployment data comprises historical deployment type associated with historical code change deployments, historical performance metrics of the network in response to deployment of each historical code change, historical deviations in network behavior identified based on the historical performance metrics, and historical responsive actions implemented to rectify the historical deviations; and
deploy the temporal deployment model on the deployment type for the code change to determine the deployment parameters.

7. The system of claim 1, wherein the system further comprises a resource optimization subsystem operatively coupled to the predictive deployment subsystem, wherein the resource optimization subsystem is configured to:
determine, using an adaptive optimization model, an optimal set of deployment resources for deploying the code change based on deployment parameters, available deployment resources in the network, historical resource utilization patterns for historical code change deployments, the real-time performance metrics, and simulated deployment scenarios; and
transmit the optimal set of deployment resources to the predictive deployment subsystem.

8. The system of claim 7, wherein the predictive deployment subsystem is further configured to:
deploy the code change with the deployment parameters using the optimal set of deployment resources.

9. The system of claim 1, wherein the system further comprises a deployment authorization subsystem operatively coupled to the predictive deployment subsystem, wherein the deployment authorization subsystem is configured to:
generate a smart contract that encodes conditional requirements and the deployment parameters for the deployment of the code change, wherein the conditional requirements comprise at least deployment approval policies for authorized stakeholders; and
record the smart contract in a distributed ledger.

10. The system of claim 9, wherein the predictive deployment subsystem is further configured to:
retrieve, from the distributed ledger, the smart contract; and
trigger automated deployment of the code change upon fulfillment of the conditional requirements.

11. A method for intelligent code deployment within a network, wherein the method comprises:
receiving, by a code change analysis subsystem, a code change from a source;
determining, by the code change analysis subsystem, a deployment type for the code change;
determining, by a predictive deployment subsystem, deployment parameters for the code change based on at least the deployment type and historical deployment data;
deploying, by the predictive deployment subsystem, the code change using the deployment parameters;
monitoring, by a deployment monitoring subsystem, the deployment of the code change;
determining, by the deployment monitoring subsystem, real-time performance metrics associated with network functionality in response to the deployment, wherein the real-time performance metrics comprise at least resource utilization, latency, and network traffic; and
detecting, by the deployment monitoring subsystem, deviations in network behavior based on the real-time performance metrics.

12. The method of claim 11, wherein the method further comprises:
determining, using a responsive action subsystem, in real-time, a responsive action associated with the detected deviations;
dynamically implementing, using the responsive action subsystem, the responsive action to rectify the detected deviations in the network behavior; and
generating, using the responsive action subsystem, an adaptive feedback loop to adjust the deployment parameters for subsequent deployments based on the detected deviations and the implemented responsive actions.

13. The method of claim 11, wherein, determining the deployment type further comprises:
determining component-level interdependencies within the network likely to result from the deployment of the code change; and
determining the deployment type for each sub-task based on the determined component-level interdependencies.

14. The method of claim 11, wherein receiving the code change from the source further comprises:
scanning the source to detect codebase modifications, script updates, and application changes;
analyzing, using a natural language processing (NLP) model, the codebase modifications, the script updates, and the application changes; and
dividing the code change into a plurality of sub-tasks based on the analysis.

15. The method of claim 14, wherein deploying the code change comprises deploying the plurality of sub-tasks using the deployment parameters.

16. The method of claim 11, wherein determining the deployment parameters further comprises:
training a temporal deployment model with historical deployment data, wherein the historical deployment data comprises historical deployment type associated with historical code change deployments, historical performance metrics of the network in response to deployment of each historical code change, historical deviations in network behavior identified based on the historical performance metrics, and historical responsive actions implemented to rectify the historical deviations; and
deploying the temporal deployment model on the deployment type for the code change to determine the deployment parameters.

17. The method of claim 11, wherein the method further comprises:
determining, using a resource optimization subsystem, an optimal set of deployment resources for deploying the code change based on deployment parameters, available deployment resources in the network, historical resource utilization patterns for historical code change deployments, the real-time performance metrics, and simulated deployment scenarios, wherein determining further comprises using an adaptive optimization model; and
transmitting, using the adaptive optimization model, the optimal set of deployment resources to the predictive deployment subsystem.

18. A computer program product for intelligent code deployment within a network, the computer program product comprising a non-transitory computer-readable medium comprising code, which when executed, causes a processing device to:
receive a code change from a source;
determine a deployment type for the code change;
determine deployment parameters for the code change based on at least the deployment type and historical deployment data;
deploy the code change using the deployment parameters;
monitor the deployment of the code change;
determine real-time performance metrics associated with network functionality in response to the deployment, wherein the real-time performance metrics comprise at least resource utilization, latency, and network traffic; and
detect deviations in network behavior based on the real-time performance metrics.

19. The computer program product of claim 18, wherein the code, when executed, further causes the processing device to:
determine, in real-time, a responsive action associated with the detected deviations;
dynamically implement the responsive action to rectify the detected deviations in the network behavior; and
generate an adaptive feedback loop to adjust the deployment parameters for subsequent deployments based on the detected deviations and the implemented responsive actions.

20. The computer program product of claim 18, wherein, in determining the deployment type, the code, when executed, further causes the processing device to:
determine component-level interdependencies within the network likely to result from the deployment of the code change; and
determine the deployment type for each sub-task based on the determined component-level interdependencies.
